(19) United States
(12) Patent Application Publication
(10) Pub. No.: US 2026/0023398 A1
(43) Pub. Date: Jan. 22, 2026

(54) METHODS AND DEVICES FOR CONTROLLING SOLAR TRACKER

(71) Applicant: Nevados Engineering, Inc., Oakland, CA (US)

(72) Inventors: Yezin Taha, San Francisco, CA (US); Jason Alderman, Oakland, CA (US); Sam Prest, Fairfield, CA (US); Rahul Chandra, Oakland, CA (US); Jenya Meydbray, Mill Valley, CA (US); Riley Caron, Oakland, CA (US)

(73) Assignee: Nevados Engineering, Inc., Oakland, CA (US)

(21) Appl. No.: 19/273,883

(22) Filed: Jul. 18, 2025

Related U.S. Application Data
(60) Provisional application No. 63/673,464, filed on Jul. 19, 2024.

(51) Int. Cl. G05D 3/10; H02S 20/32

(52) U.S. Cl. CPC G05D 3/105; H02S 20/32

(57) ABSTRACT

Devices and methods presented in this disclosure may be advantageously employed to optimize power generation and/or increase longevity of modules. In aspects of the invention, switching from backtracking mode to twin half cut module mode depending on angle of incidence and/or diffuse fraction calculations/measurements may increase power generation compared to if only one mode were used. In aspects of the invention, preventing the tracker from generating excess power may reduce temperatures of the tracker and increase longevity of its solar panels.

### CROSS REFERENCE TO RELATED APPLICATIONS

This application claims priority to U.S. Provisional Application 63/673,464 titled “METHODS AND DEVICES FOR CONTROLLING SOLAR TRACKER” filed on Jul. 19, 2024, which is incorporated by reference herein in its entirety.

### FIELD OF THE INVENTION

The invention relates generally to solar trackers, particularly methods of controlling solar trackers to improve power generation and/or solar panel longevity.

### BACKGROUND

Two types of mounting systems are widely used for mounting solar panels. Fixed tilt mounting structures support solar panels in a fixed position. The efficiency with which panels supported in this manner generate electricity can vary significantly during the course of a day, as the sun moves across the sky and illuminates the fixed panels more or less effectively. However, fixed tilt solar panel mounting structures may be mechanically simple and inexpensive, and in ground-mounted installations may be arranged relatively easily on sloped and/or uneven terrain.

Single axis tracker solar panel mounting structures allow rotation of the panels about an axis to partially track the motion of the sun across the sky. For example, a single axis tracker may be arranged with its rotation axis oriented generally North-South, so that rotation of the panels around the axis can track the East-West component of the sun's daily motion. Alternatively, a single axis tracker may be arranged with its rotation axis oriented generally East-West, so that rotation of the panels around the axis can track the North-South component of the sun's daily (and seasonal) motion. Solar panels supported by single axis trackers can generate significantly more power than comparable panels arranged in a fixed position.

Basic backtracking algorithms are often used to improve the power generation of trackers. During those times when shading is most likely to be caused in the morning and late evening hours, the angles of the solar modules are reduced (e.g., the modules are made flatter) to prevent shading.

Prevention of any shading is more important in full cell solar panels compared to split cell solar panels (also called half cell). Split cell solar panels cut the full cells in half to increase the solar panel longevity as well as decrease power generation losses from certain patterns of shading. Since the top half and bottom half of the split cells are in parallel, shading of the one half may only affect that half while still allowing the other half to continue generating power. This opens up the possibility for different optimizations of power when considered with tracking algorithms that want to point the solar panels as closely to the sun as possible in order to maximize incidence and power generation.

### SUMMARY

Devices and methods presented in this disclosure may be advantageously employed on flat, sloped and/or variable terrain to optimize power generation and/or increase longevity of modules. In embodiments of the invention, switching from backtracking mode to twin half cut module mode depending on angle of incidence and/or diffuse fraction calculations/measurements may increase power generation compared to if only one mode were used. In embodiments of the invention, preventing the tracker from generating excess power may reduce temperatures of the tracker and increase longevity of its solar panels.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a perspective view of a solar site array with three neighboring trackers and three bays of solar modules each.

FIG. 2 shows a cross section of a single tracker with three bays of solar modules on an upward slope extending along the North-South axis.

FIG. 3 shows a cross section of a solar site array with three trackers neighboring each other along the East-West axis.

FIG. 4 shows a perspective view of an all-terrain solar tracker with different bearings in between the bays of solar modules.

FIG. 5 shows a block diagram of a computer system in communication with a solar panel array.

FIG. 6 shows a block diagram of a solar panel control system in communication with a solar panel array.

FIG. 7 depicts a process to choose a mode for a solar panel array based on angle of incidence.

FIG. 8 depicts a process to choose a mode for a solar panel array based on diffuse fraction.

FIG. 9 depicts a process to choose a mode for a solar panel array based on power generation comparison and/or inverter peak rating.

FIG. 10 depicts a full cell solar panel architecture.

FIG. 11 depicts a split cell solar panel architecture.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical.”

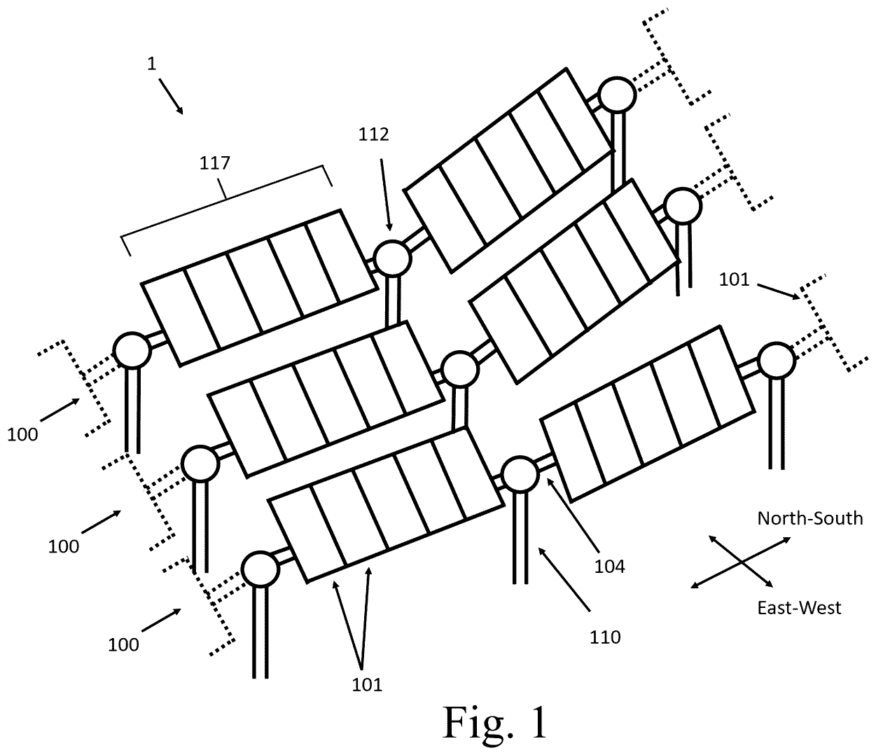

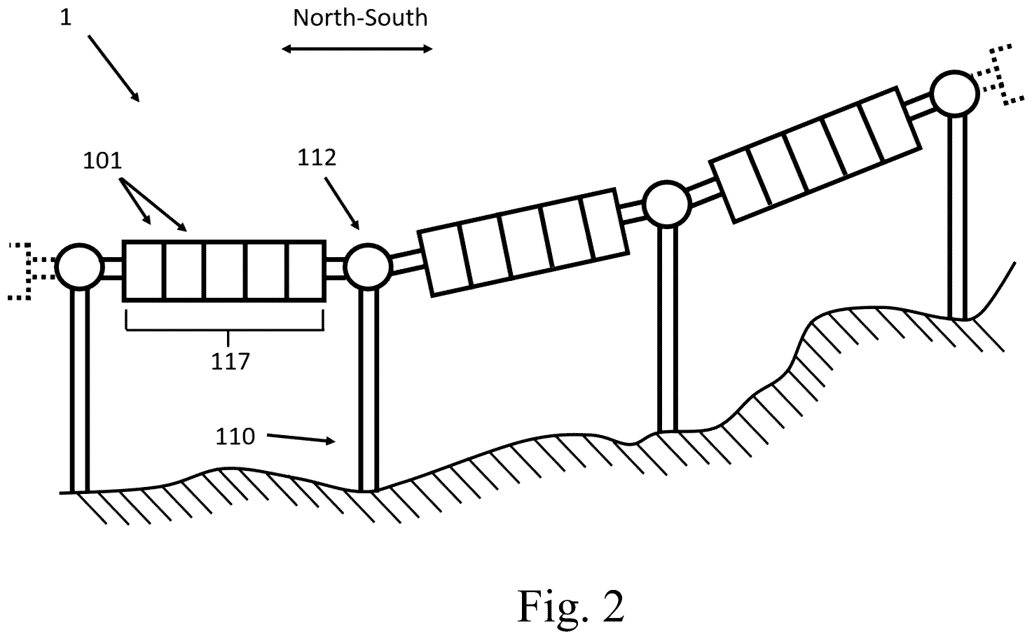

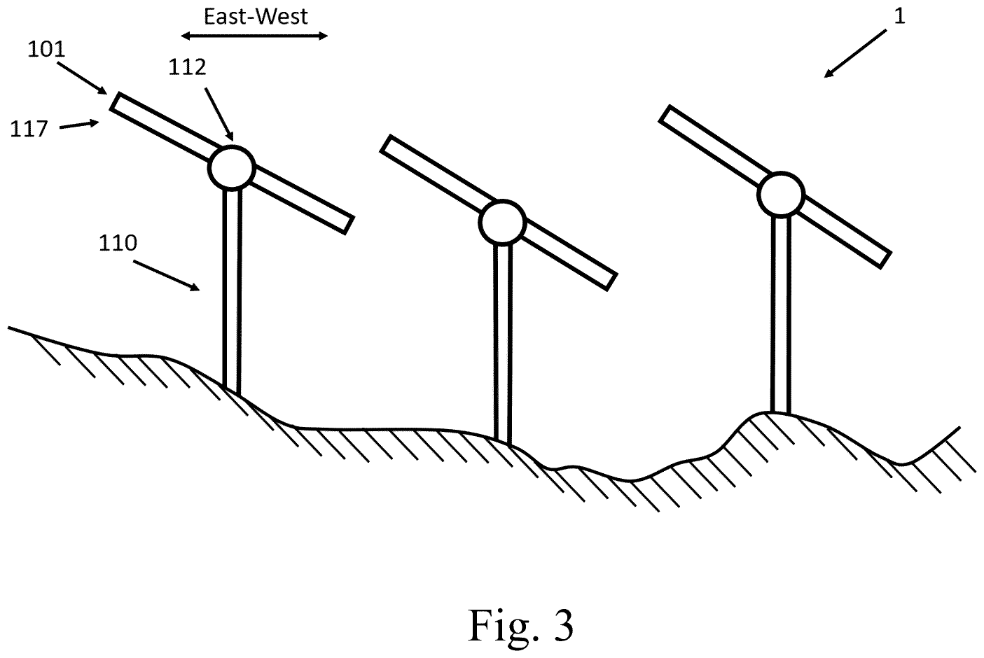

FIGS. 1-3 illustrate a solar array site including multiple trackers. FIG. 1 depicts three trackers in the solar site array directly adjacent to each other, each running along or approximately along the north-south direction with solar modules extending lengthwise in or approximately in the east-west direction. Alternatively, the trackers may run along or approximately along the east-west direction with solar modules extending lengthwise in or approximately in the north-south direction, or any other desired orientation. An angle change is depicted in all three trackers at the bearing assembly 112. The rightmost tracker on the page illustrates that a tracker or a bay 117 in a tracker may a different angle with relationship to the North-South axis than its neighbor(s). Bearing assemblies 112 disposed on a support post 110 could be any of the bearing assemblies described below, such as an articulating bearing assembly. A bay 117 includes a series of solar modules disposed directly adjacent to each other. The bay 117 may be bounded by bearing assemblies 112 and disposed on a single solar panel support 104 (e.g., a torque tube 104). A single bay 117 may have solar panel modules 101 that have parallel normal vectors and also lie on a same plane as each other, which holds true even as the torque tube rotates the solar modules (in this paper, “solar modules” is used interchangeably with “solar panels” unless otherwise stated). The bays 117 in a single tracker and/or across different trackers may have the same number of solar panel modules 101 or different number of solar panel modules 101 as each other, such as from 1 to 20 solar modules, such as from 3 to 15, such as from 5 to 10. The dashed lines at the “ends” of the trackers indicate that there may be more solar panel support 104 and solar panel modules 101 extending in one or either direction, such as more bays. FIG. 2 depicts a cross section of a solar array site looking along the east-west axis, depicting a single tracker with at least three bays 117 for case of understanding. FIG. 3 depicts a cross section of a solar site array looking along the north-south axis. Three trackers of the solar site array are depicted side by side on the sloped landscape. The solar panel modules 101 in the bays 117 are tilted away from the horizontal. For case of understanding, only one bay 117 in each of the three trackers is depicted, although in a physical site other bays further down the tracker may be visible from this perspective due to angle changes at the bearing assemblies 112.

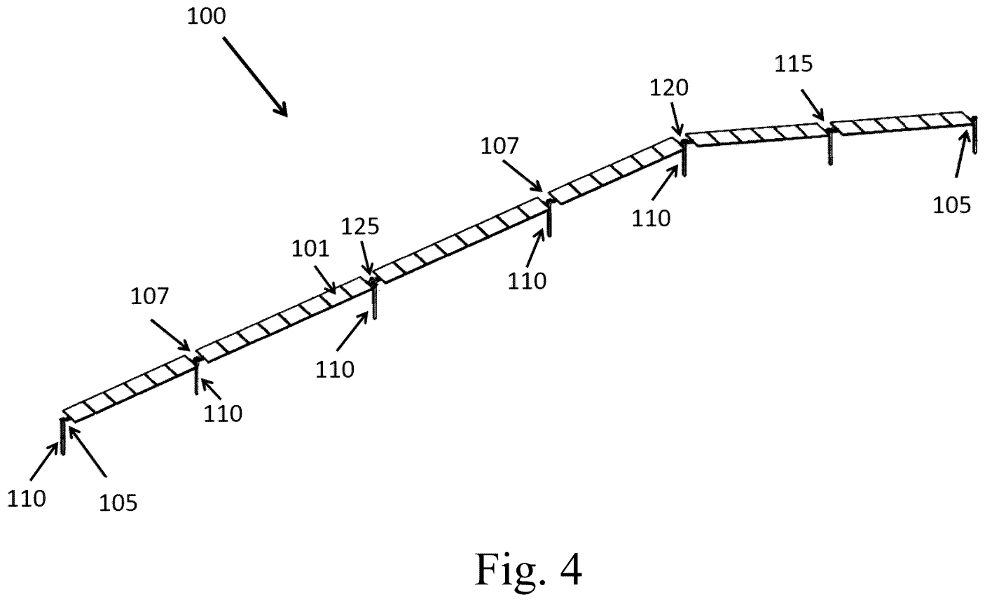

FIG. 4 shows an example of an individual all-terrain solar tracker (such as included in the solar array site described above) arranged on varying terrain with angle changes along its length to follow the natural terrain. This tracker employs examples of many of the components that may or may not be present in a tracker. These components include articulated bearings supporting significant changes in angular orientation between adjacent segments of the torque tube, flexure bearings supporting smaller changes in angular orientation between adjacent segments of the torque tube without requiring an articulated bearing, straight through bearings, mechanical stops limiting rotation of the tracker, and a row end bearing. The tracker in addition includes a slew drive configured to drive rotation of the torque tube around its long axes. Although the example of FIG. 4 and other figures shows a particular arrangement of certain components, other variations may employ any suitable combination and arrangement of the components described in this disclosure. Some elements illustrated in certain figures may be unlabeled in those figures and only be labelled in other figures, for convenience and clarity of illustration and to avoid repetition.

The variable terrain and single axis solar tracker 100 of FIG. 4 employs support posts 110, solar panel module supports 104 such as torque tubes extending between the support posts, and solar panel modules 101 supported by the torque tubes. Torque tubes may be tubes having a cross-section of four or more flat sides, such as a rectangle, square, pentagon, hexagon, and octagon, for example. Torque tubes may have cross sections that are round instead of having flat sides, such as circles or ovals. Multiple solar panel modules may be between each of the support posts, and they may all be of a same size as one another, or some of them may be different sizes from each other. The solar panel modules may each comprise a solar module frame which supports the solar cells in the panels. The number of solar panel modules between each of the support posts may be the same along the tracker, or it may vary depending on the terrain and the spacing of specific support posts. All the solar panel modules in between two of the support posts may be collectively referred to as a bay, and they may lie in the same plane as each other even as they are rotated by the tracker and slew drive.

This example variable terrain solar tracker is arranged on uneven terrain and includes two rotation axes: a first rotation axis arranged along a slope, and a second horizontal rotation axis along a flat portion of land above the slope. The angle between the first rotation axis and the second horizontal rotation axis may be, for example, ≥0 degrees, ≥5 degrees, ≥10 degrees, ≥15 degrees, ≥20 degrees, ≥25 degrees, ≥30 degrees, ≥35 degrees, ≥40 degrees, ≥45 degrees, ≥50 degrees, ≥55 degrees, ≥60 degrees, ≥65 degrees, ≥70 degrees, ≥75 degrees, ≥80 degrees, ≥85 degrees, or up to 90 degrees. These examples refer to the magnitude of the angle between the first rotation axis and the second horizontal axis. The angles may be positive or negative.

Various types of bearing assemblies 112 may be disposed on top of support posts, depending on the terrain and the position of the support post with relation to the rest of the trackers: straight-through bearing assemblies 107 for sloping planar surfaces, flat land bearing assembly 115 for flat land, row end bearing assembly 105 for an end of a the tracker, articulating joint bearing assembly 120 for changing terrain angles, and slew drive assembly 125 at an end of the tracker or an intermediate position along the tracker in order to drive rotation of the tracker.

For example, opposite ends of the tracker are rotationally supported by row end bearing assemblies 105 on support posts 110. The portion of the tracker arranged on the slope is supported by straight-through bearing assemblies 107, which include thrust bearings that isolate and transmit portions of the slope load to corresponding support posts 110. The portion of the tracker arranged on flat land, above the slope, is rotationally supported by a flat land bearing assembly 115 which may be a conventional pass-through bearing assembly lacking thrust bearings as described above. The slew drive assembly may drive rotation of the solar panel modules 101 about the first and second rotation axes to track the sun. The solar panel modules 101 may be supported on torque tubes that are parallel with and optionally displaced (e.g., displaced downward) from the rotation axis of the slew drives. The torque tubes may also be aligned with rather than displaced from the rotation axis of the slew drives. Articulating joint bearing assembly 120 links the two non-collinear rotation axes and transmits torque between them. Example configurations for bearing assemblies 105, 107 and 120 are described in more detail below.

Other variations of the variable terrain solar tracker 100 may include other combinations of bearing assemblies 105, 107, 115, and 120 arranged to accommodate one, two, or more linked rotational axes arranged along terrain exhibiting one or more sloped portions and optionally one or more horizontal (flat) portions. Two or more such trackers may be arranged, for example next to each other in rows, to efficiently fill a parcel of sloped and/or uneven terrain with electricity-generating single axis tracking solar panels.

As noted above articulating joint bearing assembly 120 accommodates a change in direction of the rotational axis along the tracker. As used herein, “articulating joint” refers to a joint that can receive torque on one axis of rotation and transmit the torque to a second axis of rotation that has a coincident point with the first axis of rotation. This joint can be inserted between two spinning rods that are transmitting torque to allow the second spinning rod to bend away from the first spinning rod without requiring the first or second spinning rod to flex along its length. One joint of this type, which may be used in articulating joint bearing assemblies as described herein, is called a Hooke Joint and is characterized by having a forked yoke that attaches to the first spinning rod, a forked yoke attached to the second spinning rod, and a four-pointed cross between them that allows torque to be transmitted from the yoke cars from the first shaft into the yoke cars of the second shaft.

The processes and methods described in this specification may be implemented by a hardware computer system. A computer system may include at least one of a processor, memory, non-volatile storage, and an interface. A typical computer system may include at least one or more of the following: a processor, memory, a general-purpose central processing unit (CPU), such as a microprocessor, and/or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software may be stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this description. Even when software is moved to the memory for execution, the processor may make use of hardware registers to store values associated with the software, and local cache that, ideally, serves to speed up execution. A software program may be assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The computer systems can be compatible with or implemented as part of or through a cloud-based computing system. As used in this description, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this description can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this description, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor may transform data into new data using implemented data structures and methods, such as is described with reference to the FIGS. in this description.

The engines described herein, or the engines through which the systems and devices described herein can be implemented, can be cloud-based engines. A cloud-based engine may be an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

Datastores may include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

Datastores can include data structures. A data structure may be associated with a particular way of storing and organizing data in a computer so that it can be used efficiently within a given context. Data structures may be based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure may entail writing a set of procedures that create and manipulate instances of that structure. The datastores can optionally be cloud-based datastores. A cloud-based datastore may be a datastore that is compatible with cloud-based computing systems and engines.

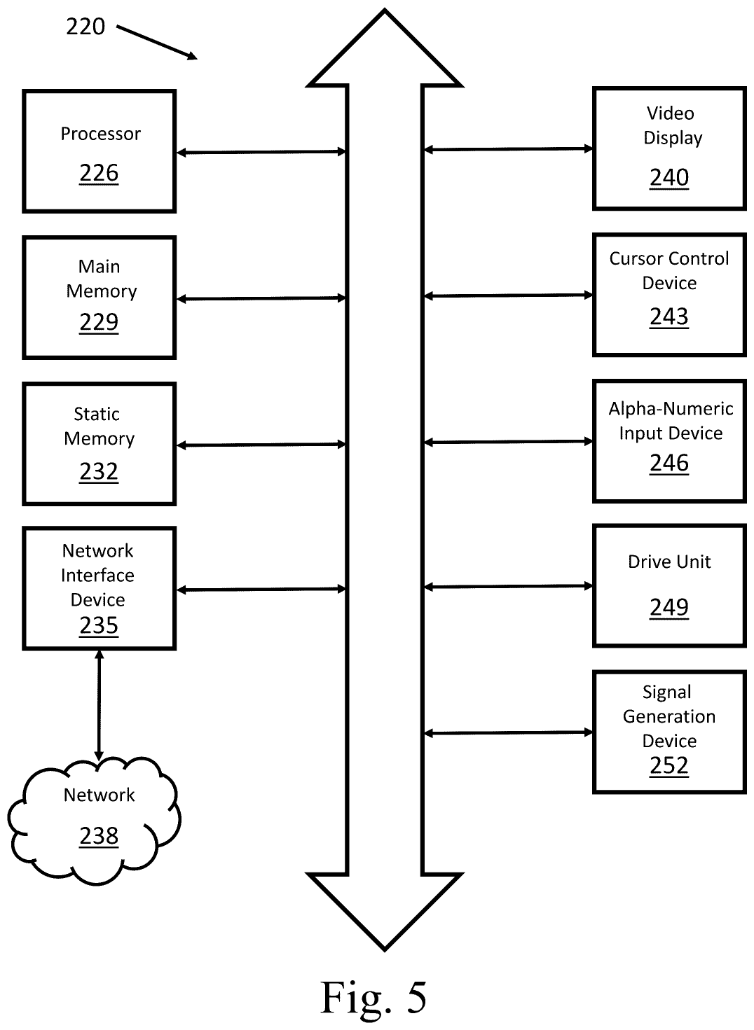

FIG. 5 is a block diagram of a machine in the example form of a computer system 220 within which instructions for causing the machine to perform any one or more of the methodologies discussed herein may be stored and/or executed. The machine may operate as a standalone device or may be connected (e.g., network) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 220 may include a processor 226 (e.g., a central processing unit (CPU), a graphics processing unit (GPU) or both), a main memory 229 and a static memory 232, which communicate with each other via a bus 223. The computer system 220 may further include a video display unit 240 (e.g., a liquid crystal display (LCD) or a cathode ray tube (CRT)). The computer system 220 also includes an alphanumeric input device 246 (e.g., a keyboard), a user interface (UI) navigation (or cursor control) device 243 (e.g., a mouse), a disk drive unit 249, a signal generation device 252 (e.g., a speaker) and a network interface device 235 connected to a network 238.

The disk drive unit 249 (e.g., a hard disk) may include a computer-readable medium on which is stored one or more sets of data structures and instructions (e.g., software and/or algorithms) embodying or utilized by any one or more of the methodologies or functions described herein. The instructions may also reside, completely or at least partially, within the main memory 229 and/or within the processor 226 during execution thereof by the computer system 220, the main memory 229 and the processor 226 also may constitute machine-readable media. The instructions may also reside, completely or at least partially, within the static memory 232.

The term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks. Machine-readable media may also include random access memory (RAM) (such as dynamic RAM (DRAM) and static RAM (SRAM)).

The instructions may further be transmitted or received over a communications network 238 using a transmission medium. The instructions may be transmitted using the network interface device 235 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software. The network interface device 235 may include one or more modems, network interface cards, wireless network interfaces or other interface devices, such as those used for coupling to Ethernet, token ring, or other types of networks.

Embodiments of the computer system may not require every element illustrated in FIG. 5 to be present, such that elements depicted in FIG. 5 may be optional. For example, an embodiment of a computer system used to implement embodiments of the invention may not include a signal generation device 252 or a cursor control device 243.

Some portions of the detailed description herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

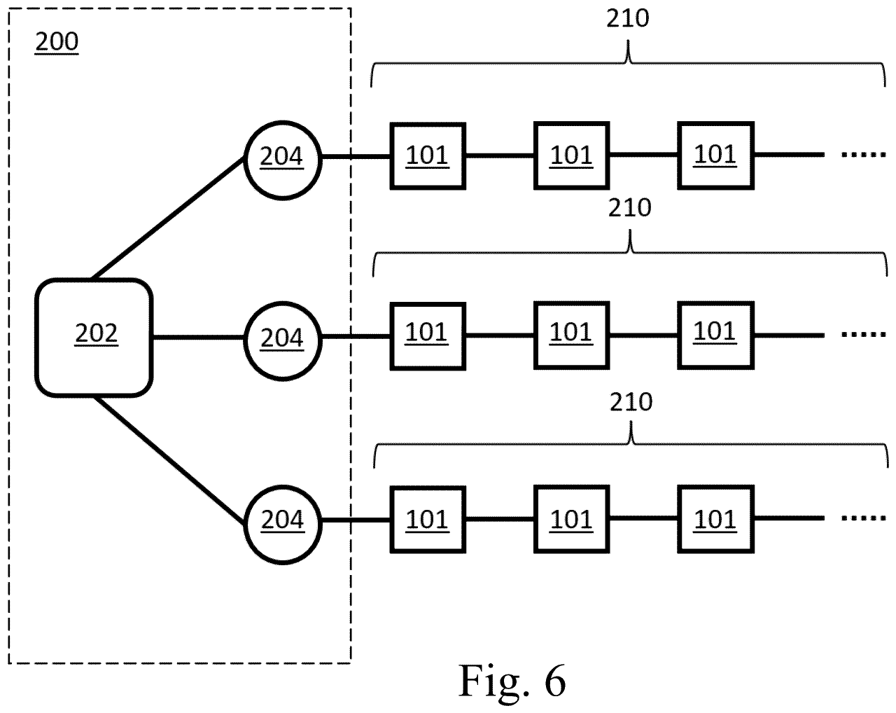

FIG. 6 shows an example of a solar panel array control system 200 coupled to a solar panel array. The solar panel array control system 200 may communicate with the solar panel array. The solar panel array control system 200 and/or elements of the solar panel array control system 200 (such as the central controller 202 and/or group control systems 204) may include, be included in, be in communication with, or consist of the computer system 220 or elements of the computer system 220 described above.

The solar panel array may include one or more solar panel groups 210 each including one or more solar panel modules 101. The groups 210 may include one or more solar panels connected in series, in parallel, or any combination thereof. The solar panel groups may include rows of solar panels, and may be trackers 100 as described above. Any description herein of rows of solar panels may apply to any other type of arrangement or grouping of solar panels.

Optionally, each group of solar panels may each have (e.g., be coupled to and in communication with) a group control system 204. Each group control system 204 may control operation their respective solar panel group 210. The group control systems 204 may be referred to as row controllers when controlling rows of solar panels. Any number of solar panel groups and/or group control systems may be provided. Each group may comprise any number of solar panels. Each group may have the same number of solar panels or differing numbers of solar panels. A central controller 202 may optionally be provided that may control the group control systems.

The solar panel array control system 200 may comprise the central controller 202 and, optionally, one or more group control systems 204. In some instances, one-way communication may be provided from the central controller to the one or more group control systems. The central controller may send instructions to the one or more group control systems, which may in turn control operation of the corresponding solar panel groups. In some instances, two-way communication may be provided between the central controller and the one or more group control systems. For instance, the group control systems may be group controllers that may send data to the central controller. The central controller may send instructions to the group controllers, for example in response to, or based on, the data received from the group controllers. The data from the one or more group controllers may optionally include data from one or more solar panels, or various types of sensors physically included as part of the solar panel group (e.g., on a torque tube, foundation, bearing assembly, or other part of the tracker), physically remote from the solar panel group, and/or otherwise physically or electrically coupled to the solar panel group.

The solar panel array control system may direct and affect operation of the solar panels, which may include positioning of the solar panels. The control system may affect an orientation of the solar panel. The control system may control amount of rotation, rate of rotation, and/or acceleration of rotation of one or more solar panels. The control system may affect a spatial disposition of the solar panel. The control system may control an amount of translation, speed of translation, and/or acceleration of translation of one or more solar panels. The control system may affect operation of one or more driving mechanisms for a solar panel array, for example by sending signals to the slew drive coupled to one or each of the solar panel groups, which may then control orientation of the solar panels. The solar panels may be positioned in response to one or more factors, as previously described herein. The solar panel array control system may affect other operations of the solar panels, such as turning the solar panels on or off, operational parameters of converting the solar energy to electrical energy, diagnostics, error detection, calibration, or any other type of operations of the solar panels.

In one example, a method of optimizing power generation throughout a field of trackers may be provided. Operational data for each grouping (e.g., each row) of solar panels may be provided. Any description herein of a row may apply to any grouping. The method may include collecting row-level operational data in aggregate, or piecemeal, to determine the operational characteristics of one or more rows of trackers. Power generation data of each row may be measured to determine if shading is occurring from one row to the next. The method may include analyzing total field power generation to determine if shading specific rows, while further optimizing or adjusting the tilt of other rows for generating power, will increase overall field power generation.

Row-level tests may be performed to determine the impact of shading of one or more rows on the one or more neighboring rows with regard to power generation of the neighboring rows. Row-level tests may be performed on one or more rows to determine if an optimum orientation assumption yields optimum or increased power generation. Tracking schedules may be updated to optimize or increase power generation throughout a tracker field or for each individual row. Row-level power generation may be monitored and compared with weather station reports to determine if sun-tracking operations or non-sun-tracking operations will yield greater power generation. Based on the comparison, an operation may be selected to yield the greater power generation.

### Backtracking

A basic tracking algorithm used by many trackers is called true-tracking. Its aim is relatively simple: to minimize the incidence angle between the normal vector of the solar panel and the incoming beam from the sun. Solar panels are lain flat at solar noon and are tilted early and later in the day to face the sun when it is at low elevation. The steep tilt during certain times may cause shading between trackers, resulting in potentially significant power loss from a pure true-tracking approach. This shading by trackers on other trackers is often referred to as row-to-row shading, since a tracker can be thought of as a row of solar modules, even when there are angle changes within the tracker.

Basic backtracking algorithms were developed to improve on true-tracking. During those times when shading is most likely to be caused in the morning and late evening hours, the angles of the solar modules are reduced (e.g., the modules are made flatter) to prevent or reduce shading. These basic backtracking algorithms assume that the trackers are on an entirely flat plane. In essence, a basic backtracking algorithm may include minimizing angle of incidence for all the solar panels in the array while preventing all shading for each of these solar panels.

More advanced backtracking algorithms, which can be termed cross-slope aware backtracking, take into account that two trackers may each have different planes (higher or lower) in the east or west. The angle between these two planes, called the cross-axis slope, extends infinitely such that all trackers that fall within the scope of each algorithm run will inherit the same cross axis slope. Cross-slope aware backtracking can fail to prevent shading in three ways. First, if the cross-axis slope is not constant throughout the entire site, and there are any slope changes, the algorithm may fail to take those changes into account and prevent row-to-row shading. Second, if the trackers have differing slopes along the tracker axis direction, then the two planes of the trackers are not parallel with one another, which could also cause issues. Lastly, even if the slopes in the tracker axis direction are taken into account, such algorithms may only consider the slope of the tracker as a whole, when there can be changes in slope between the posts within each tracker. These changes can also cause a failure to prevent shading.

Even more advanced backtracking algorithms, which can be called terrain aware backtracking, take in to account not only the different planes in the cast or west, but the relative terrain in other directions, such as for example the planes in the tracker axis direction. This allows prevention or minimization of any shading on the solar panel even for relatively uneven terrain.

When a mode is referred to as a backtracking mode in this specification, it may refer to physically controlling a solar site array or part of the solar site array in accordance with any backtracking algorithm (unless otherwise stated), including the ones discussed above, and in particular terrain aware backtracking, which may prevent interrow shading in the solar array, or reduce it in comparison to other algorithms (such as the twin half cut module algorithm described below). Operating solar panels in such a mode may refer to such physical controlling of the solar panels. For example, operating a solar array in backtracking mode may comprise rotating one or more neighboring trackers, bays, or solar panels to prevent shading between them. For example, the trackers may rotate one or both of a first solar panel and a neighboring second solar panel about one or more respective axes to a different angular orientation than they started out with to completely prevent either one from shading the other. Operating the array in a backtracking mode may also include determining a schedule of angular orientations for the pertinent solar panels or groupings of solar panels, i.e., a series of angles for consecutive time steps in an operation interval; then controlling the solar panels to follow that schedule.

### Split Cells

Compared to full cell solar cells, split cell solar cells (a.k.a. half cut solar cells) allow one half of the solar module to be shaded while the other maintains full performance. Because solar cells generally perform better when they are pointed directly at the sun, this allows flexibility in optimizing how a tracker orients their solar cells in relation to other trackers in the solar site. In a full cell solar panel the shading of one cell in a string may eliminate the full string from producing power. While this is still true in a split cell solar module, the strings in the split cell solar module may be half the length of the power producing part of the solar module rather than the entire length. As a result, shading part of the string in the split cell solar module may only result in half the power production loss in the entire solar module compared to a full cell. For example, a full cell solar module may have three strings each extending the full length of the solar module (i.e., along the longest dimension) and arranged next to each other, while the split cell solar module may have six strings with three strings arranged at a top half of the solar module and three strings arranged at a bottom half; each of these six strings are half the length of the solar module.

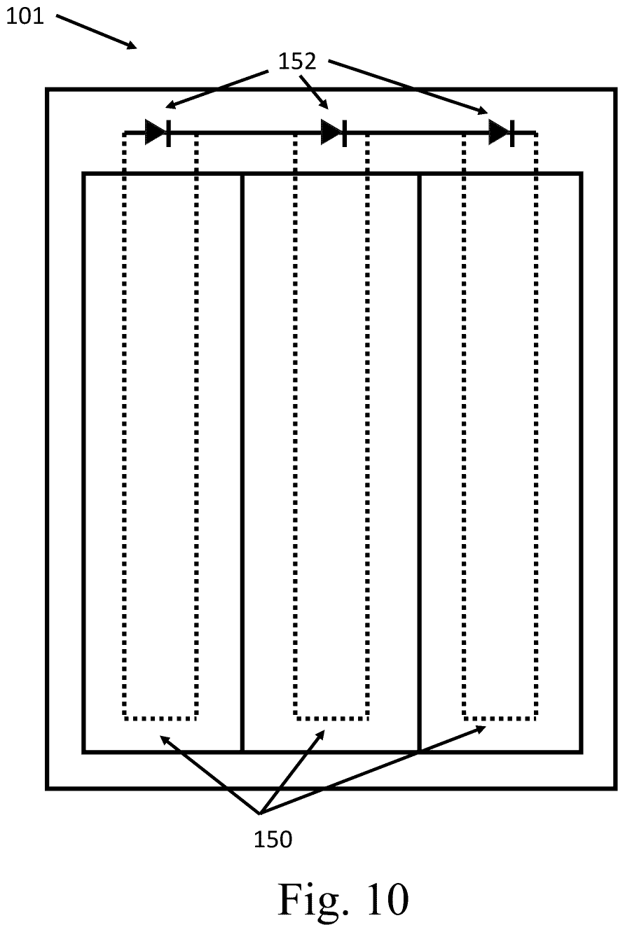

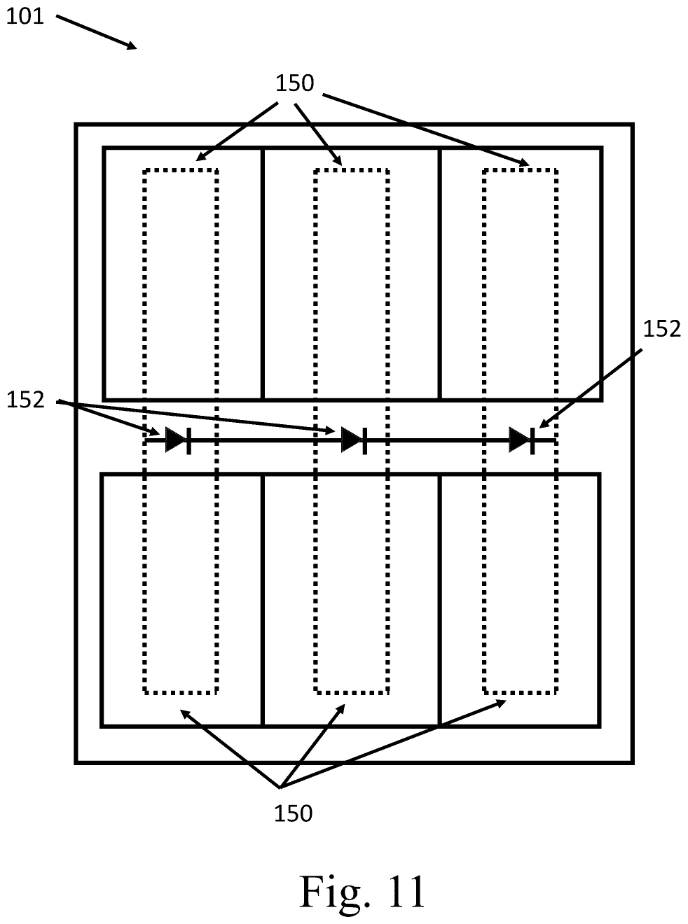

FIG. 10 shows a full cell solar panel module, while FIG. 11 shows a split cell solar panel module. In FIG. 10, there are three strings 150 in the solar panel with diodes 152. When for example the entire bottom 50% of the solar panel is shaded, all three strings 150 stop producing power. In FIG. 11, there are six strings 150, three on top and three on bottom, with diodes 152 between the halves. Even when the entire bottom 50% of the solar panel is shaded, the top three strings 150 can still produce power.

### Twin Half Cut Module

A twin half cut module algorithm takes advantage of the architecture of split cells. It involves allowing and/or causing split cells to be shaded above 0% and up to 50% in order to optimize power generation, for example of the entire solar array of the solar site. The shading may be done by an adjacent solar panel, such as a solar panel at an neighboring row to the shaded solar module. For example, a first bay may be shaded up to 50% in order to point either the first bay, the second bay, or both directly or more directly at the sun compared to if backtracking mode were implemented to eliminate shading on the first bay to 0%. The power production benefit of pointing the bay(s) more directly at the sun may outweigh the loss associated with the intentional shading. (Unless otherwise stated, shading percentage in this specification may refer to the shading percentage of areas in the solar panel that can generate power, not necessarily non-generating areas such as a frame of a solar panel.)

When a mode is referred to as a twin half cut module mode in this specification, it may refer to controlling the solar site array or part of the solar site array according to the twin half cut module algorithm discussed above. Operating solar panels in the mode may refer to such controlling. For example, operating a solar array in twin half cut module mode may comprise rotating one or more neighboring trackers, bays, or solar panels to intentionally shading one or more of them while pointing one or more of them more directly at the sun. For example, the trackers may rotate one or both of a first solar panel and a neighboring second solar panel so that they are at a different angular orientation than they started out with, so that one of them may intentionally shading them from greater than 0% to 50%, such as from greater than 10% to 30%, while pointing one or more of them more directly at the sun. Operating the array in a twin half cut module mode may also include determining a schedule of angular orientations for the pertinent solar panels or groupings of solar panels, i.e., a series of angles for consecutive time steps in an operation interval; then controlling the solar panels to follow that schedule.

### Angle of Incidence Switching

Important to a solar panel's power generation at any given time is its angle of incidence, which is the angle between the normal on the solar panel's planar surface and the sun's rays. The angle of incidence may be a time dependent feature. For example, the path of the sun from sunrise to sunset may be different at different seasons. In the northern hemisphere, the sun may be farther south in the winter compared to in the summer. This may result in a greater angle of incidence for a solar panel oriented at a given angle during the winter compared to the angle of incidence at that same orientation in the summer (at least on average). For example, take the case of a flat solar panel (e.g., whose plane may be perpendicular to the direction of the Earth's gravity and/or parallel to flat ground, and/or whose normal vector may be parallel to the earth's gravity). When the sun is lower, such as in the winter, the flat solar panel may have a greater angle of incidence than in the summer, for a particular time and/or on average throughout the day.

When the angle of incidence at any given time grows large enough to reach a certain threshold or above, it may make sense to switch the trackers at a solar site from backtracking mode to twin half cut module mode. At this point the loss associated with intentionally shading certain trackers or strings may be offset by the increased power production gained from decreasing the angle of incidence of other trackers or strings. For example, the energy lost from intentionally shading one half of a single solar panel may be offset by the power gained from pointing the other half more towards the sun. Similarly, when the angle of incidence falls from at or above the threshold to below that threshold, it may make sense to switch the tracker from twin half cut module mode to backtracking mode. Here, the benefit of pointing the unshaded half of the solar panel directly or more directly at the sun may be less than, or equal to, the loss associated with shading (at least part of) the other half of the solar panel. Twin half cut module may no longer be desired in that case, and backtracking mode to reduce or eliminate shading may comparatively increase total power generation of the solar site. As a note, pointing a solar panel directly at the sun may mean that the angle of incidence between the sun's rays and the normal of the solar panel is minimized at that time of day given the mechanical freedom of rotation the solar panel has once it is installed in the tracker. For example, a solar panel may be installed to allow rotation around the rotation axis of its supporting torque tube without allowing any rotation around a second axis perpendicular to the rotation axis (even if the solar panel may be tilted around the second axis). In one example, the solar panel may freely rotate in the east-west directions around a rotation axis extending in the south-north directions, and may not rotate in the south-north directions around a second axis extending in the east-west directions. The minimization may include finding the angular orientation of the solar panel around the rotation axis which obtains the lowest angle of incidence compared to other angular orientations around the rotation axis. Alternatively or additionally, the minimization include finding the angular orientation of the solar panel around the rotation axis which obtains the lowest angle of incidence compared to other angular orientations around the rotation axis plus some other condition, such as without resulting in shading of over 50% of the solar panel and/or a neighboring solar panel. The minimization may result in a nonzero or zero angle of incidence. When a solar panel is intentionally not pointed directly at the sun, such as during certain times in backtracking mode to avoid or reduce interrow shading, the angle of incidence may not be minimized. This may mean that out of all possible angular orientations mechanically allowed by the tracker, an angular orientation other than that obtaining the lowest angle of incidence is not chosen.

One way of describing the geometry of a bay is that it may have an imaginary halfway line extending lengthwise through it, dividing one of the half cut solar cell portions of the panels in the bay from the other half cut portion. In this way, the bay may consist of two mirrored, respectively continuous areas that have the same size and shape as each other, each extending in a lengthwise direction of the bay, and each having a same angular orientation on the tracker no matter how the tracker rotates the bay. Each of these halves may include entire half cut cells without including any incomplete half cut cells. Shading the bay by 50% or less could mean that the half cut solar cell portions above the imaginary halfway line experiences no shading at all; that is, one of the two areas of the bay may experience greater than 0% up to 100% shading, while the other area of the bay experiences 0% shading. This helps make sure there is not electrical loss from both the half cut solar cell portions of the bay, only one of them at most. Alternatively or additionally, shading the bay by 50% or less could mean that the entire total area of the bay is shaded less 50% or less.

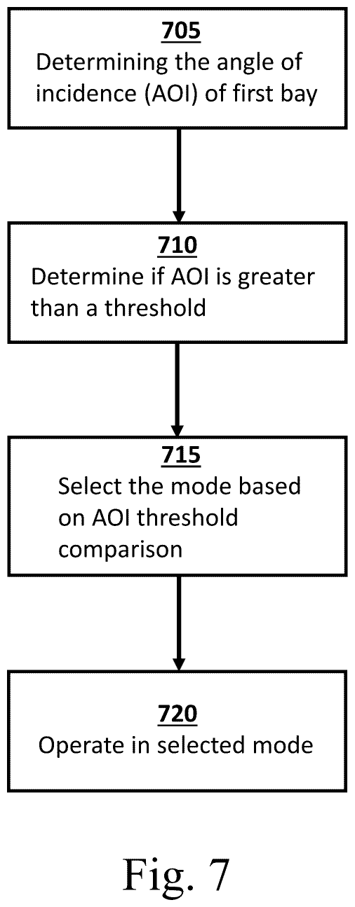

FIG. 7 shows embodiments of the invention, including a process for selecting modes of the solar array as detailed below.

At 705, determine the angle of incidence of a first bay at a first time. The angle of incidence may be the angle between the solar panel's surface and the sun's light rays. (The word “bay” as used in this process and specification, may be substituted for by other groupings of solar panels except where otherwise stated; these other groupings may include single solar panels, trackers, etc). The first time may be a future time and date different from when the determination is made, such the determination may be done at an initial time before the first time. The AOI may be determined based upon the future time and date, the topography of the solar site which the first bay is/will be installed in, the sun's calculated path/position at that future time and date, a chosen angular orientation of the first bay at the time (e.g., where the AOI is minimized for that time), and/or the positions/angular orientations of one or more neighboring bays at the first time. The AOI may be determined before the solar array including the first bay is installed at the solar site. Alternatively, the AOI may be determined in real time during operation of the installed solar array (either at the first time or an initial time before the first time), and based on real time measurements obtained from the tracker and one or more of its measuring instruments.

At 710, determine if the AOI is beyond a threshold. The threshold may be a predetermined or calculated threshold set to ensure that when it is used to determine between switching from one mode to another (e.g., backtracking or twin half cut module), the mode which is switched to will generate more power for the solar array than the previous mode. The threshold may be, for example, from 50-80%, such as from 55-75%, such as from 60-70%, such as 70%.

At 715, select the mode which the first bay and/or all the bays in the solar array is to be operated at based on where the AOI falls in relation to the threshold. For example, if the AOI is greater the threshold, the selection may be to operate the solar array in twin half cut module mode at the first time; if the AOI is equal to or less than the threshold, the selection may be to operate the solar array in backtracking mode at the first time.

At 720, at the first time, operate the first bay and/or the solar panel array at the selected mode, e.g., twin half cut module or backtracking mode. For example, if twin half cut module mode is selected, the first bay may be intentionally shaded by a neighboring second bay of the solar panel array to point the first bay and/or the second bay more directly at the sun.

In the process above, the solar array may already be operating in a particular mode before the AOI is determined at 705 and/or before another mode is selected at 715 and used at 720. For example, the solar array may be operating at twin half cut module mode or backtracking mode at an previous time before the first time and after the initial time, and the mode selected at 715 may be the same mode or a different mode than the mode at the previous time. When the solar panel array is operated in the selected mode at 720, it may result in rotating the solar panels to a different angular orientation at the first time, or keeping the solar panels in the same angular orientation at the first time even if the new mode is a different mode than used at the previous time.

Since the process includes intelligently switching between backtracking and twin half cut module modes, the solar panel array may achieve greater power generation than if only one mode were used for the day or any other time interval.

### Diffuse Fraction

Another factor in a solar panel's power generation is the diffuse fraction/ratio, which is the ratio of the diffuse solar radiation to the global solar radiation. When the diffuse fraction meets or exceeds a certain threshold, it may make sense to switch the tracker mode, e.g., from twin half cut module mode to backtracking mode. This may be because, when the diffuse fraction is high, the benefit of pointing the unshaded half of the solar panel directly at the sun may be less than the loss associated with shading at least part of the other half of the solar panel. When the diffuse fraction is higher, the solar panel may get less benefit from being pointed more directly at the sun compared to when the diffuse fraction is lower. Instead, it may be preferable to have the solar panels flatter than pointing them directly at the sun, as that may generate more power comparatively.

When the diffuse fraction decreases below the threshold, it may make sense to switch the tracker mode from backtracking mode to twin half cut module mode. The increase in power generation from pointing more directly at the sun may exceed the loss associated with intentional shading.

Alternatively or additionally, rather than having a diffuse fraction threshold and a separate angle of incidence threshold or rather than just having those, the solar tracker may measure the current diffuse fraction around the tracker and use that measurement to adjust the angle of incidence threshold. Then, that adjusted angle of incidence threshold may be used to determine tracker mode switching, as described in FIG. 7 and accompanying text above.

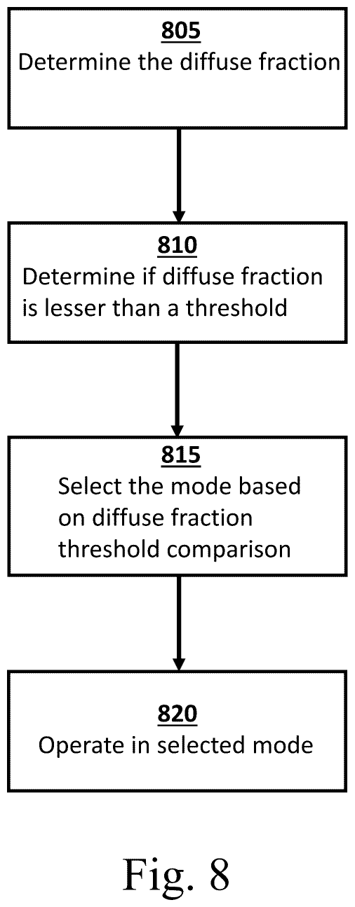

FIG. 8 shows embodiments of the invention, including a process for selecting modes of the solar array as detailed below.

At 805, determine the diffuse fraction around/above the solar site in which the solar panel array is installed. The determination may be a measurement made by one or more measurement instruments included in or as part of the solar panel array and/or tracker, and may include directly measuring string current and/or power and/or using a pony module (i.e., a solar panel that may be smaller than the other modules, may be attached to the slew drive without being disposed on a torque tube, and may power a row controller controlling the tracker). The measurement may be made at a first time, or at an initial time before the first time. The measurement may include measuring the diffuse solar radiation around the solar panel array and the global solar radiation around the solar panel array, and dividing the former with the latter to obtain the diffuse fraction. The measurement may be done in real time during operation of the solar panel, or may be a forecast and/or prediction of the diffuse fraction at a later time than when it is made. The diffuse fraction may be obtained from third party API (such as Solcast for example), or local sensors at the solar site physically spaced apart from the solar tracker(s).

At 810, determine if the diffuse fraction is lesser than the threshold. The threshold may be a predetermined or calculated threshold set to ensure that when it is used to determine between switching from one mode to another (e.g., backtracking or twin half cut module), the mode which is switched to will generate more power for the solar array than the previous mode. The threshold may be, for example, from 50-75%, such as from 55-70%, such as from 60-65%, such as 65%.

At 815, select the mode which the first bay and/or all the bays in the solar array is to be operated at based on where the diffuse fraction falls in relation to the threshold. For example, if the diffuse fraction is lesser than the threshold, the selection may be to operate the solar array in twin half cut module mode at a first time or second time after the first time; if the diffuse fraction is equal to or greater than the threshold, the selection may be to operate the solar array in backtracking mode at the first time or second time after the first time.

At 820, at the first time or a second time after the first time, operate the first bay and/or the solar panel array at the selected mode, e.g., twin half cut module or backtracking mode. For example, if twin half cut module mode is selected, the first bay may be intentionally shaded by a neighboring second bay of the solar array to point the first bay and/or the second bay more directly at the sun.

In the process above, the solar array may already be operating in a particular mode before the diffuse fraction is determined at 805 and/or before a mode is selected at 815 and used at 820. For example, the solar array may be operating at twin half cut module mode or backtracking mode at an initial time before the first time, and the mode selected at 815 may be the same mode or a different mode than the mode at the initial time. When the solar panel array is operated in the selected mode at 820, it may result in rotating the solar panels to a different angular orientation at the first time, or keeping the solar panels in the same angular orientation at the first time even if the new mode is a different mode than used at the initial time.

Additionally, the process above may be so that when the solar panel is operated in backtracking mode, it is operated in an adjusted backtracking mode due to the high amount of diffuse solar radiation around the solar site. For example, in the usual backtracking mode, the solar panels in the array may be pointed as directly toward the sun as possible while maintaining no shading at all on any of the power generating portions of the solar panels in the array. Pointing the solar panels as directly at the sun as possible captures more light and increases power generation. However, when the amount of diffuse solar radiation is high, rotating the solar panels to a flatter angular orientation (i.e., closer to or at horizontal) may increase the power generation compared to pointing them more at the sun. Thus, the adjusted backtracking mode may include angular orientations flatter than a normal backtracking mode, such that rather than being pointed as directly towards the sun as possible in order to prevent shading, the solar panels are oriented closer to flat compared to that more direct angle while still keeping shading at 0%. In embodiments of the invention, there may be more than one threshold against which the diffuse fraction is compared to at 810, and the more thresholds the diffuse fraction is higher than, the more adjusted the adjusted backtracking mode is used to operate the solar panel array. For example, there may be anywhere from two to five thresholds, each one higher than the other. For each successive threshold that the diffuse fraction exceeds, a different adjusted backtracking mode is used, such that the respective angular orientations of each adjusted backtracking mode are flatter the higher the threshold the adjusted backtracking mode corresponds to.

Since the process above may include intelligently switching between backtracking and twin half cut module modes, the solar panel array may achieve greater power generation than if only one mode were used for the day or any other time interval.

### Inverter Clipping

A solar site may include one or more solar trackers and various devices coupled to the trackers to facilitate collection of energy. One of these devices may be an inverter. The inverter may convert the direct current (DC) electricity generated by the solar panel to useable alternating current (AC) electricity. The one or more solar trackers may be all connected to a single inverter. Alternatively, there may be multiple inverters physically located at the solar site. For example, each of the solar trackers may be connected to their own inverter which converts the current of their own tracker, without being connected to any other. More granular configurations may be implemented, where each bay or even each solar panel may have their own inverters. In addition to the one or more trackers, the inverter may be coupled to the public electric grid to deliver the collected energy.

Each inverter may have a maximum or peak rating, which is the maximum power the inverter may handle or collect. The solar panel or array of solar panels electrically connected to an inverter may collect more power than the peak rating. In this case inverter clipping occurs, where the extra electricity collected by the solar panels cannot be collected by the inverters and is in this sense wasted.

While clipping may sometimes viewed as undesirable, the amount of extra power collected by the solar panel array over the peak rating may be viewed as a margin that can be reduced or maintained without affecting the efficiency of power collection. In other words, other aspects of the solar panels may be optimized while reducing power collection, as long as the reduction of power collection does not make the power generated fall below the peak rating.

For example, if the solar panel array is pointed at the sun at a first angle which causes inverter clipping (or equals the peak rating), the array may be rotated to point at the sun with a second angle greater than the first to generate less electricity from the array than before. At the second angle the array may still cause clipping or generate power meeting the peak rating of the inverter. This means the reduction in amount of power generated by the array does not matter, since the same amount of power is ultimately collected by the inverter. However, the position at the second angle may optimize another aspect of the solar panel array. For example, the array at the second angle may be pointed less directly at the sun compared to the first angle or first mode, causing a drop in temperature of the solar panel array. Since the array runs less hot in the second position or second mode, this improves the overall lifetime of the array compared to if it were positioned at the first angle. Additionally or alternatively, the second angle may prevent the power generation from damaging the inverter by excessive clipping. Excessive clipping may be when the power collected by the array exceeds the peak rating by a predetermined amount, and the second angle may decrease the power collected below the predetermined amount, compared to the first angle which exceeds the peak rating by at least that predetermine amount.

Additionally, the presence of inverter clipping may be used to inform which mode (backtracking vs. twin half cut module) to operate the array at. For example, the presence of inverter clipping may be used to determine that the array should be swapped from one operating mode to the other. Alternatively, the presence of inverter clipping may be used to determine to stay operating at the current mode when other measurements or events would otherwise determine that the array should be swapped to a different mode. For example, if one of the processes outline in FIG. 7 or 8 selects a desired mode based on AOI and/or diffuse fraction threshold comparison, the presence of inverter clipping in a current operating mode or mode used for calculation may override that selection to choose a different mode than the desired mode instead. Alternatively, the presence of inverter clipping in a current operating mode or mode used for calculation may bypass the mode selection outlined in FIG. 7 or 8.

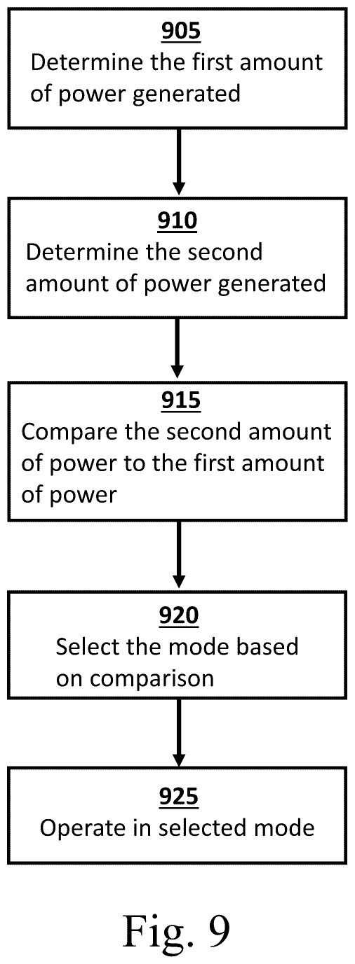

FIG. 9 shows embodiments of the invention, including a process for selecting modes of the solar array as detailed below.

At 905, determine a first amount of power generated by the first solar panels operating in a first mode at a first time. The determination may be a measurement made by one or more measurement instruments included in and/or coupled to the solar panel array, and the measurement may be made at a first time, or at an initial time before the first time. The determination may also be done by calculation and/or software modeling, where the physical first solar panels do not need to be operating in the first mode for the determination to be done. If the determination is done by measurement then the first solar panels may be operating in the first mode at the time the measurement is taken. This determination may include determining whether the first amount of power is at or greater than the peak rating of the inverter it is connected to, or simply just greater than the peak rating. If it is, then it may make sense to find out whether switching to another mode would be preferable, for a number of reasons outlined below.

At 910, determine a second amount of power generated by the first solar panels operating in a second mode at a first time or at a second time. The determination may be a measurement made by one or more measurement instruments included in and/or coupled to the solar panel array, and the measurement may be made at a first time, at an initial time before the first time, or at a second time after the first time. The determination may also be done by calculation and/or software modeling, where the physical first solar panels do not need to be operating in the first mode for the determination to be done. If the determination is done by measurement then the first solar panels may be operating in the first mode at the time the measurement is taken. In one example, the determination of the second amount of power may be a calculation made at an initial time before the first time, the first solar panels are operated at the first mode at the first time, and the determination at 905 is made at the first time after the initial time as a measurement. This determination may include determining whether the second amount of power is at or greater than the peak rating of the inverter it is connected to, or simply just greater than the peak rating. This will help determine whether the first or second mode is preferable.

At 915, compare the second amount of power to the first amount of power, e.g., to find out whether one is greater than the other and/or by how much. In embodiments of the invention, this comparison may only be made if it has already been determined that the first and second amount of power are both at or above the peak rating of the inverter (or just above the peak rating), although this is not a requirement.

At 920, select the mode which the first solar panels and/or all the solar panels in the solar array are to be operated at based on the comparison at 915. For example, if the first amount of power is greater than the second amount of power, and neither of them are below the peak rating of the inverter, then it may be decided that the second mode generating the lesser second amount of power is preferable, as operating in the second mode may lead to cooler solar panels while still generating the same amount of collectible power. In this example, the first mode may be the twin half cut module mode while the second mode may be the backtracking mode.

At 925, operate the first solar panels and/or all the solar panels in the solar array in the selected mode, e.g., twin half cut module or backtracking mode.

Since the process may include intelligently prevents generating excess power that cannot be collected, the solar panel array may achieve reduced temperatures and greater longevity than if such process were not implemented. For example, the process may stop the solar panel array from operating in modes that generate more power (such as twin half cut module mode) in situations where it otherwise would have switched to those more power optimal modes, when such excess power cannot be collected. For example, the process the switch the solar panel array from operating in a first mode (e.g., twin half cut module mode) that operates at a first temperature (e.g., at a first time) than a second mode (e.g., backtracking mode) that operates at a second temperature lower than the first temperature (e.g., at a second time after the first time). In embodiments of the invention, the process above may be used with either full cell solar panels or split cell solar panels in the solar panel array, or a combination of the two.

One type of system that may remotely monitor/control solar sites is called supervisory control and data acquisition (SCADA). SCADA can acquire and process real-time data from the solar sites. SCADA may be connected to the trackers and/or the inverters at the solar site, and/or to the various controllers and/or sensors physically located at the solar site. The connection may be physical/electrical and/or SCADA may be communicative through a network to those elements. SCADA may be operating on a computer at the solar site or remote from the solar site. Most or all of the data in a solar site may be gathered by SCADA, and SCADA may send commands to some or all the devices in the solar site, including trackers. As one example, SCADA may command one or more trackers to operate at backtracking mode or twin half cut module mode, or other modes as described in this specification. Some of the real-time or historical data collected by SCADA may include power collected by one or more inverters, irradiance on and/or temperature experienced by the one or more solar modules, weather conditions such as wind speed, air pressure, rain, snow, flood, or hail experienced by the solar site, and operating status of devices at the solar site.

With regards to the processes described above, SCADA has the capability to query an inverter to determine whether or not it is clipping. The inverter may inform SCADA whether clipping is occurring, which may be useful information in, say, 905 of the process outlined in FIG. 9. Alternatively, SCADA may query inverter to see how much power it is collecting, and when SCADA knows the peak rating of the inverter, it may infer clipping from the actual power and peak rating.

SCADA systems may include software, hardware, network, and other systems, such as one or more elements shown in FIG. 5. For example, SCADA may a server or servers with an interface for human control such as a computer terminal, which may be coupled to a communication network that the tracker/sensors/controllers/devices of the solar site are coupled to. For example, servers in the SCADA system may be connected by a fiber line to one or more devices at the solar site, such as an inverter, sensors, and/or controllers. SCADA may also be connected to the internet and send data it has collected through the internet. Some, most, or all of the SCADA systems may be located offsite from the solar site.

This disclosure is illustrative and not limiting. Further modifications will be apparent to one skilled in the art in light of this disclosure and are intended to fall within the scope of the appended claims.

An embodiment of the invention includes a method for controlling movement of solar panels within a solar panel array under solar illumination, the method including: determining the angle of incidence (AOI) of a first bay of the solar panel array when the first bay is at a first angular orientation at a first time; determining whether the angle of incidence is greater than a threshold; and controlling the solar array such that: if the AOI is greater than the threshold, operating the solar array in twin half cut module mode at the first time; and if the AOI is not greater than the threshold, operating the solar array in backtracking mode at the first time.

The method wherein the first bay comprises half-cut solar cells.

The method wherein twin half cut module mode comprises pointing a first area of the first bay directly at the sun while intentionally shading a second area of the first bay.

The method wherein intentionally shading the second area of the first bay comprises shading the first bay at 50% or less of a total area of the first bay.

The method wherein pointing the first area of the first bay directly at the sun comprises minimizing an angle of incidence of the first area without shading the first bay above 50% of the total area of the first bay.

The method wherein intentionally shading the second area of the first bay comprises shading the second area only without shading any of the first area, the first area and the second area including entire half-cut solar cells without including any incomplete half-cut solar cells.

The method wherein the solar panel array comprises a second bay of the solar panel array neighboring the first bay, and twin half cut module mode comprises intentionally shading the second area of the first bay with the second bay.

The method wherein intentionally shading the second area of the first bay with the second bay comprises rotating the second bay to shade the first bay.

The method wherein intentionally shading the second area of the first bay with the second bay comprises rotating the first bay to be shaded by the second bay.

The method wherein intentionally shading the second area of the first bay with the second bay comprises rotating the first bay and the second bay.

The method wherein the backtracking mode comprises preventing any shading of the first bay and not pointing the first bay directly at the sun.

The method wherein not pointing the first bay directly at the sun comprises orienting the first bay at a first angular orientation that does not minimize an angle of incidence of the first bay.

The method wherein the determining the AOI is done at an initial time before the first time.

An embodiment of the invention includes a method for controlling movement of solar panels within a solar panel array under solar illumination, the method including: operating the solar array in a backtracking mode at a first time; determining the angle of incidence of a first bay in the solar array at a second time after a first time; determining the angle of incidence to be greater than a threshold; and switching an operating mode of the solar array from the backtracking mode to a twin half cut module mode at the second time.

The method wherein the first bay comprises half-cut solar cells.

The method wherein the twin half cut module mode comprises pointing a first area of the first bay directly at the sun while intentionally shading a second area of the first bay.

The method wherein intentionally shading the second area of the bay comprises shading the first bay 50% or less of a total area of the first bay.

The method wherein intentionally shading the second area of the bay comprises shading the second area only without shading any of the first area, and the first area and the second area comprise entire half-cut solar cells without comprise partial half-cut solar cells.

The method wherein the backtracking mode comprises eliminating shading of the first bay without pointing the first bay directly at the sun.

An embodiment of the invention includes a method for controlling movement of solar panels within a solar panel array under solar illumination of a sun, the method including: at a first time, causing a first bay of the solar panel array to intentionally shade a second bay of the solar panel array not more than half a total area of the second bay, at least one of the first bay and the second bay pointed directly at the sun, and at a second time, controlling at least one of the first bay and the second bay to eliminate the intentional shading of the second bay, and orient at least one of the first bay and the second bay to not be pointed directly at the sun.

An embodiment of the invention includes a method for controlling movement of solar panels within a solar panel array under solar illumination, the method including: operating the solar panel array in a twin half cut module mode at a first time; measuring diffuse fraction of solar illumination around the solar panel at the first time; determining that the diffuse fraction is greater than a threshold; and operating the solar panel array in a backtracking mode at a second time based on determining that the diffuse fraction is greater than the threshold.

The method wherein the solar panels in the solar panel array include half-cut cells.

The method wherein measurement of the diffuse fraction is done by a light sensor of the solar panel array.

The method wherein measuring the diffuse fraction includes measuring at least one of the current, voltage, and power generated by a solar panel of the solar panel array.

The method wherein twin half cut module mode includes pointing a first area of a first bay of the solar panel array directly at the sun while intentionally shading a second area of the first bay.

The method wherein intentionally shading the second area of the first bay includes shading the first bay at 50% or less of a total area of the first bay.

The method wherein the second area of the first bay is intentionally shaded by a second bay of the solar panel array, and intentionally shading includes rotating only one of the first bay and the second bay.

The method wherein the second area of the first bay is intentionally shaded by a second bay of the solar panel array, and intentionally shading the second area of the first bay with the second bay includes rotating the first bay and the second bay.

The method wherein the backtracking mode includes preventing any shading of a first bay of the solar panel array and not pointing the first bay directly at the sun.

An embodiment of the invention includes a method for controlling movement of solar panels within a solar panel array under solar illumination, the method including: measuring diffuse fraction of solar illumination around the solar panel array; determining whether the diffuse fraction falls below a threshold; and controlling the solar panela array such that: if the diffuse fraction falls below the threshold, operate the solar panel array in twin half cut module mode; and if the diffuse fraction does not fall below the threshold; operate the solar panel array in backtracking mode.

The method wherein the solar panels in the solar panel array include half-cut cells.

The method wherein measurement of the diffuse fraction is done by a light sensor of the solar panel array.

The method wherein measuring the diffuse fraction includes measuring at least one of the current, voltage, and power generated by a solar panel of the solar panel array.

The method wherein twin half cut module mode includes pointing a first area of a first bay of the solar panel array directly at the sun while intentionally shading a second area of the first bay.

The method wherein intentionally shading the second area of the first bay includes shading the first bay at 50% or less of a total area of the first bay.

The method wherein the second area of the first bay is intentionally shaded by a second bay of the solar panel array, and intentionally shading includes rotating only one of the first bay and the second bay.

The method wherein the second area of the first bay is intentionally shaded by a second bay of the solar panel array, and intentionally shading the second area of the first bay with the second bay includes rotating the first bay and the second bay.

The method wherein the backtracking mode includes preventing any shading of a first bay of the solar panel array and not pointing the first bay directly at the sun.

An embodiment of the invention includes a method for controlling movement of solar panels within a solar panel array under solar illumination of a sun, the method including: controlling a first bay of the solar panel array to point the first bay directly at the sun at a first time, the first bay oriented at a first angular orientation; measure diffuse fraction of solar illumination around the solar panel array at the first time; rotating the first bay of the solar panel array to a second angular orientation, the second angular orientation being closer to a horizontal direction than the first angular orientation.

The method wherein the solar panels in the solar panel array include half-cut cells.

An embodiment of the invention includes a method for controlling movement of solar panels within a solar panel array under solar illumination, the method including: determine a first amount of power generated by the first solar panels operating in a first mode at a first time, the first amount of power being at or above a peak rating of an inverter coupled to the first solar panel array, determine a second amount of power generated by the first solar panels operating in a second mode at the first time or a second time after the first time, selecting a subsequent mode from the first mode or the second mode, based on at least one of: whether the second amount of power is below the peak rating of the inverter, and comparing the first amount of power and the second amount of power, and at the second time after the first time, operating the first solar panels at the subsequent mode.

The method wherein the first mode is a twin half cut module mode and the second mode is a backtracking mode.

The method wherein the subsequent mode is selected to be the second mode.

The method wherein the second amount of power is at or above the peak rating of the inverter.

The method wherein the first amount of power is greater than the second amount of power.

The method wherein at the first time, the first solar panels are operating in the first mode.

The method wherein at the first time, the first solar panels are operating in the second mode.

The method wherein the subsequent mode is selected to be the first mode.

The method wherein the second amount of power is below the peak rating of the inverter.

The method wherein at the first time, the first solar panels are operating in the first mode.

The method wherein at the first time, the first solar panels are operating in the second mode.

The method wherein determining the first amount of power includes measuring power generated by the first solar panels operating in the first mode at the first time.

The method wherein determining the second amount of power includes calculating power generated by the first solar panels operating in the second mode at the first time.

An embodiment of the invention includes a method for controlling movement of solar panels within a solar panel array under solar illumination, the method including: at a first time, controlling first solar panels of the solar panel array according to a first mode, determining a first amount of power generated by the first solar panels operating at the first mode, the first amount of power being at or above a peak rating of an inverter coupled to the first solar panels, determining a second amount of power generated by the first solar panels controlled at the first time or a second time according to a second mode, the second time being after the first time, determining that the first solar panels should be operated at the second mode based on the second amount of power being at or above the peak rating of the inverter and less than the first amount of power, and operating the first solar panels in the second mode.

The method wherein the first mode is a twin half cut module mode and the second mode is a backtracking mode.

The method wherein the subsequent mode is selected to be the second mode.

The method wherein the second amount of power is at or above the peak rating of the inverter.

The method wherein the first amount of power is greater than the second amount of power.

The method wherein the subsequent mode is selected to be the first mode, and the second amount of power is below the peak rating of the inverter.

An embodiment of the invention includes a method for controlling movement of solar panels within a solar panel array under solar illumination, the method including: determine a first amount of power generated by the first solar panels operating in a first mode at a first time, the first amount of power being at or above a peak rating of an inverter coupled to the first solar panel array, determine a second amount of power generated by the first solar panels operating in a second mode at the first time, the second amount of power being above the peak rating of an inverter coupled to the first solar panel array and below a predetermined threshold that is the sum of a peak rating plus a predetermined amount of power, the second amount of power being greater than the first amount of power, and at a second time after the first time, operating the first solar panels at the second mode.

What is claimed is:

1. A method for controlling movement of solar panels within a solar panel array under solar illumination, the method comprising:
determining the angle of incidence (AOI) of a first bay of the solar panel array when the first bay is at a first angular orientation at a first time;
determining whether the angle of incidence is greater than a threshold; and
controlling the solar array such that:
if the AOI is greater than the threshold, operating the solar array in twin half cut module mode at the first time; and
if the AOI is not greater than the threshold, operating the solar array in backtracking mode at the first time.

2. The method of claim 1, wherein the first bay comprises half-cut solar cells.

3. The method of claim 1, wherein twin half cut module mode comprises pointing a first area of the first bay directly at the sun while intentionally shading a second area of the first bay.

4. The method of claim 3, wherein intentionally shading the second area of the first bay comprises shading the first bay at 50% or less of a total area of the first bay.

5. The method of claim 4, wherein pointing the first area of the first bay directly at the sun comprises minimizing an angle of incidence of the first area without shading the first bay above 50% of the total area of the first bay.

6. The method of claim 3, wherein intentionally shading the second area of the first bay comprises shading the second area only without shading any of the first area, the first area and the second area comprising entire half-cut solar cells without comprising any incomplete half-cut solar cells.

7. The method of claim 1, wherein the solar panel array comprises a second bay of the solar panel array neighboring the first bay, and twin half cut module mode comprises intentionally shading the second area of the first bay with the second bay.

8. The method of claim 7, wherein intentionally shading the second area of the first bay with the second bay comprises rotating the second bay to shade the first bay.

9. The method of claim 7, wherein intentionally shading the second area of the first bay with the second bay comprises rotating the first bay to be shaded by the second bay.

10. The method of claim 7, wherein intentionally shading the second area of the first bay with the second bay comprises rotating the first bay and the second bay.

11. The method of claim 1, wherein the backtracking mode comprises preventing any shading of the first bay and not pointing the first bay directly at the sun.

12. The method of claim 11, wherein not pointing the first bay directly at the sun comprises orienting the first bay at a first angular orientation that does not minimize an angle of incidence of the first bay.

13. The method of claim 1, wherein the determining the AOI is done at an initial time before the first time.

14. A method for controlling movement of solar panels within a solar panel array under solar illumination, the method comprising:
operating the solar array in a backtracking mode at a first time;
determining the angle of incidence of a first bay in the solar array at a second time after a first time;
determining the angle of incidence to be greater than a threshold; and
switching an operating mode of the solar array from the backtracking mode to a twin half cut module mode at the second time.

15. The method of claim 1, wherein the first bay comprises half-cut solar cells.

16. The method of claim 1, wherein the twin half cut module mode comprises pointing a first area of the first bay directly at the sun while intentionally shading a second area of the first bay.

17. The method of claim 16, wherein intentionally shading the second area of the bay comprises shading the first bay 50% or less of a total area of the first bay.

18. The method of claim 17, wherein intentionally shading the second area of the bay comprises shading the second area only without shading any of the first area, and the first area and the second area comprise entire half-cut solar cells without comprise partial half-cut solar cells.

19. The method of claim 17, wherein the backtracking mode comprises eliminating shading of the first bay without pointing the first bay directly at the sun.

20. A method for controlling movement of solar panels within a solar panel array under solar illumination of a sun, the method comprising:
at a first time, causing a first bay of the solar panel array to intentionally shade a second bay of the solar panel array not more than half a total area of the second bay, at least one of the first bay and the second bay pointed directly at the sun, and
at a second time, controlling at least one of the first bay and the second bay to eliminate the intentional shading of the second bay, and orient at least one of the first bay and the second bay to not be pointed directly at the sun.
